(19) United States
(12) Patent Application Publication
(10) Pub. No.: US 2011/0103513 A1
(43) Pub. Date: May 5, 2011

(54) APPARATUS AND METHOD OF MULTI-ANTENNA TRANSMITTING FOR TERRESTRIAL DTV BROADCASTING SIGNAL AND ADDITIONAL DATA

(75) Inventors: Jeongchang Kim, Daejeon (KR); Jae Hyun Seo, Daejeon (KR); Heung Mook Kim, Daejeon (KR); Hyoungsoo Lim, Daejeon (KR); Sung Ik Park, Daejeon (KR)

(73) Assignee: ELECTRONICS AND TELECOMMUNICATIONS RESEARCH INSTITUTE, Daejeon (KR)

(21) Appl. No.: 12/855,034

(22) Filed: Aug. 12, 2010

(30) Foreign Application Priority Data
Oct. 29, 2009 (KR) 10-2009-0103471
Feb. 12, 2010 (KR) 10-2010-0013289

(51) Int. Cl. H04L 27/00

(52) U.S. Cl. 375/299

(57) ABSTRACT

Provided is a transmission apparatus and method for a terrestrial digital TV (DTV) broadcast and additional data using a multi-antenna. To transmit additional data inserted in a base band of a terrestrial DTV broadcast signal using a plurality of transmission antennas, the additional data signal may be temporal and spatial encoded or may be temporal and spatial multiplexed, and may be combined with a base band DTV broadcast signal before modulation and thus, a transmission efficiency of the additional data may increase without affecting a performance of an existing terrestrial DTV broadcast receiver.

### CROSS-REFERENCE TO RELATED APPLICATION(S)

This application claims the benefit of Korean Patent Application Nos. 10-2009-0103471 and 10-2010-0013289, respectively filed on Oct. 29, 2009 and Feb. 12, 2010, in the Korean Intellectual Property Office, the disclosures of which are incorporated herein by reference.

### BACKGROUND

1. Field of the Invention

The present invention relates to a transmission apparatus and method for a terrestrial digital TV (DTV) broadcast and additional data transmission.

2. Description of the Related Art

A method of transmitting additional data along with a main service symbol of a terrestrial digital TV (DTV) broadcast is one of various terrestrial DTV broadcast transmission schemes.

Data information, such as program information, stock information, and the like, is provided, during the DTV broadcast, based on a scheme of occasionally inserting additional data into a DTV signal and thus, a maximum transmission capacity of the DTV broadcast may decrease, an amount of the decrease being the same as an amount of the inserted data.

### SUMMARY

An aspect of the present invention provides a transmission apparatus and method for a terrestrial digital TV (DTV) broadcast and additional data using a multi-antenna.

According to an aspect of the present invention, there is provided a transmission apparatus for a broadcasting service, and the apparatus includes a main service symbol generating unit to generate main service symbols for a main service, a temporal and spatial mapping unit to perform temporal and spatial mapping of the main service symbols to a plurality of transmission antennas, an additional data symbol generating unit to generate additional data symbols for an additional data service, a temporal and spatial encoder to perform temporal and spatial encoding of the additional data symbols, and a processor to generate symbols to be transmitted via the plurality of transmission antennas based on the main service symbols and the additional data symbols.

The temporal and spatial mapping unit may be at least one switch that switches each to of the main service symbols to be mapped to a unique transmission antenna, among the plurality of transmission antennas, at different time slots. The temporal and spatial mapping unit may be at least one switch that switches the main service symbols to be mapped to the plurality of transmission antennas at the same time slot.

The processor may include a combiner to combine outputs of the temporal and spatial mapping unit and outputs of the temporal and spatial encoder, and a modulator to modulate outputs of the combiner to generate symbols to be transmitted via the plurality of transmission antennas.

The combiner may add the outputs of the temporal and spatial mapping unit and the outputs of the temporal and spatial encoder. The modulator modulates, based on at least one predetermined modulation scheme, signals combined by the combiner.

The temporal and spatial encoder may generate the temporal and spatial encoded symbols so that T×M symbols may be transmitted via M transmission antennas during a T time duration.

According to an aspect of the present invention, there is provided a transmission method for a broadcasting service, and the method includes generating main service symbols for a main service, performing temporal and spatial mapping of the main service symbols to a plurality of transmission antennas, generating additional data symbols for an additional data service, performing temporal and spatial encoding of the additional data symbols, and generating symbols to be transmitted via the plurality of transmission antennas based on the main service symbols and the additional data symbols.

The mapping may switch each of the main service symbols to be mapped to a unique transmission antenna, among the plurality of transmission antennas at different time slots, using at least one switch. The mapping may switch the main service symbols to be mapped to the plurality of transmission antennas at the same time slot, using at least one switch.

The generating may include combining, by a combiner, the temporal and spatial to mapped main service symbols and the temporal and spatial encoded additional data symbols; and modulating, by a modulator, outputs of the combiner to generate symbols to be transmitted via the plurality of transmission antennas.

The combining may add the temporal and spatial mapped main service symbols and the temporal and spatial encoded additional data symbols.

The modulating may modulate, based on at least one predetermined modulation scheme, signals combined by the combiner.

The temporal and spatial encoding may generate the temporal and spatial encoded symbols so that T×M symbols are transmitted via M transmission antennas during a T time duration.

According to an embodiment, a terrestrial DTV broadcast and additional data may be transmitted via a plurality of transmission antennas and thus, a transmission efficiency may increase without affecting an existing terrestrial DTV receiver.

According to an embodiment, to transmit an additional data inserted in a base band of a terrestrial DTV broadcast signal using a plurality of transmission antennas, an additional data signal may be temporal and spatial encoded or may be temporal and spatial multiplexed, and may be combined with a base band DTV broadcast signal before modulation and thus, a transmission efficiency of the additional data may increase without affecting a performance of an existing terrestrial DTV broadcast receiver.

Additional aspects, features, and/or advantages of the invention will be set forth in part in the description which follows and, in part, will be apparent from the description, or may be learned by practice of the invention.

### BRIEF DESCRIPTION OF THE DRAWINGS

These and/or other aspects, features, and advantages of the invention will become apparent and more readily appreciated from the following description of embodiments, to taken in conjunction with the accompanying drawings of which:

FIG. 1 is a diagram illustrating an example of a transmission apparatus for a terrestrial DTV broadcast and additional data transmission;

FIG. 2 is a block diagram illustrating a transmission apparatus that provides a terrestrial DTV broadcast and transmits additional data via a plurality of antennas according to an embodiment of the present invention;

FIG. 3 is a block diagram illustrating a detailed example of a temporal and spatial mapping unit of FIG. 2;

FIG. 4 is a block diagram illustrating another detailed example of a temporal and spatial mapping unit of FIG. 2;

FIG. 5 is a block diagram illustrating an example of a combiner;

FIG. 6 is a block diagram illustrating an example of a modulator; and

FIG. 7 is a flowchart illustrating a method of providing a terrestrial DTV broadcast and transmitting additional data via a plurality of antennas according to an embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

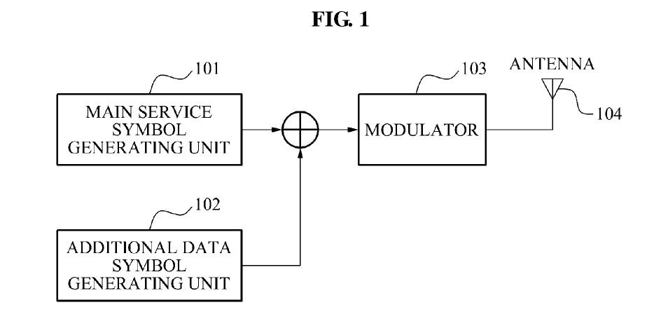

FIG. 1 illustrates an example of a transmission apparatus for a terrestrial digital TV (DTV) broadcast and additional data transmission.

Referring to FIG. 1, the transmission apparatus for the terrestrial DTV broadcast and additional data transmission may include a main service symbol generating unit 101, an additional data symbol generating unit 102, a modulator 103, and a single transmission antenna 104.

The main service symbol generating unit 101 may generate symbols for the terrestrial DTV broadcast, the additional data symbol generating unit 102 may generate symbols for the additional data, and the modulator 103 may modulate symbols generated in the main service symbol generating unit 101 and the additional data symbol generating unit 102. The modulated signal may be transmitted via the signal transmission antenna 104.

According to the transmission apparatus or a transmission method of FIG. 1, a terrestrial DTV broadcast signal and the additional data may be simultaneously transmitted and thus, the additional data may be transmitted without affecting an existing terrestrial DTV receiver. However, the transmission using the single antenna may limit an increase in transmission efficiency.

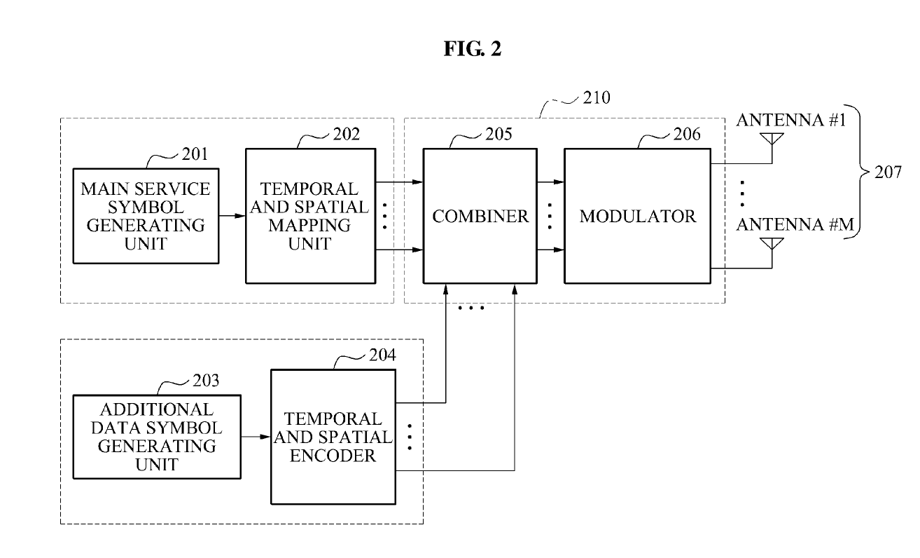

FIG. 2 illustrates a transmission apparatus that provides a terrestrial DTV broadcast and transmits additional data via a plurality of transmission antennas 207 including an antenna #1 through an antenna #M according to an embodiment of the present invention.

Referring to FIG. 2, the transmission apparatus for the terrestrial DTV broadcast and the additional data may include a main service symbol generating unit 201, a temporal and spatial mapping unit 202, an additional data symbol generating unit 203, and a temporal and spatial encoder 204.

The main service symbol generating unit 201 may generate main service symbols for a terrestrial DTV broadcast main service.

The temporal and spatial mapping unit 202 may map the main service symbols generated by the main service symbol generating unit 201 to the plurality of transmission antennas.

The additional data symbol generating unit 203 may generate additional data symbols for an additional data service. The additional data service may be a service to provided in addition to a DTV broadcast service. A transmission of the additional data may provide additional broadcast service in addition to the existing DTV broadcast, and may provide data service such as an education service, a stock service, a public announcement service, and the like, in addition to the existing DTV service. In addition, additional information, such as program information, associated with the main service may be transmitted. A range of the additional data service may not be limited thereto, and a variety of information may be included.

The temporal and spatial encoder 204 may perform temporal and spatial encoding of the additional data symbols generated by the additional data symbol generating unit 203, and may generate symbols to be transmitted to the plurality of transmission antennas. The temporal and spatial encoder 204 may receive, as inputs, K additional data symbols from the additional data symbol generating unit 203, K being an integer number, and may generate T×M temporal and spatial encoded symbols to be transmitted to the M transmission antennas during a T time duration.

The processor 210 may generate symbols to be transmitted via the plurality of transmission antennas 207 based on the main service symbols and the additional data symbols. The processor 210 may include a combiner 205 and a modulator 206.

The combiner 205 may combine outputs of a temporal and spatial mapping unit 202, which are mapped to the plurality of transmission antennas in the temporal and spatial mapping unit 202, and signals encoded by the temporal and spatial encoder 204.

The modulator 206 may modulate the combined signals combined in the combiner 205 to be transmitted via the plurality of transmission antennas 207, and the modulated signals may be transmitted via the plurality of transmission antennas 207.

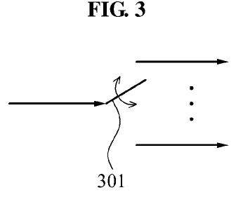

FIG. 3 illustrates a detailed example of a temporal and spatial mapping unit 202 of FIG. 2.

Referring to FIG. 3, the temporal and spatial mapping unit 202 may receive, as inputs, main service symbols generated by the main service symbol generating unit 201, and may map each of the main service symbols to a unique antenna, among the plurality of transmission antennas 207, at different times, using at least one switch 301.

A turn-on time and a turn-off time of each of transmission antennas may be fixed as a predetermined value or may randomly vary. A sequence of a turn-on and a turn-off of each of transmission antennas may be fixed as a predetermined value or may randomly vary. Therefore, a temporal and spatial mapping may be performed based on an optimal turn-on time, an optimal turn-off time and an optimal sequence of turn-on and turn-off.

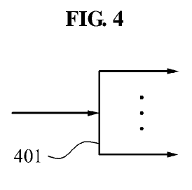

FIG. 4 illustrates another detailed example of the temporal and spatial mapping unit 202 of FIG. 2.

Referring to FIG. 4, the temporal and spatial mapping unit 202 may receive, as inputs, main service symbols that the main service symbol generating unit 201 generates using at least one switch 401, and may map the main service symbols to the plurality of transmission antennas 207 at the same time. The temporal and spatial mapping unit 202 may map the main service symbols to all the plurality of transmission antennas 207 at the same time.

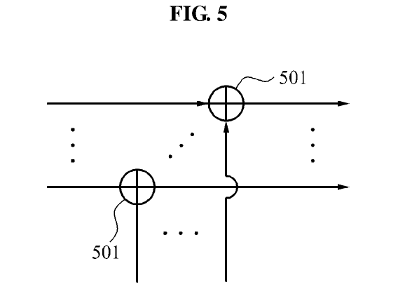

FIG. 5 illustrates an example of a combiner.

Referring to FIG. 5, the combiner 205 may include an adder 501 that adds signals mapped with respect to transmission antennas, namely, outputs of the temporal and spatial mapping unit 202, and outputs of the temporal and spatial encoder 204, and may combine both the outputs using the adder 501.

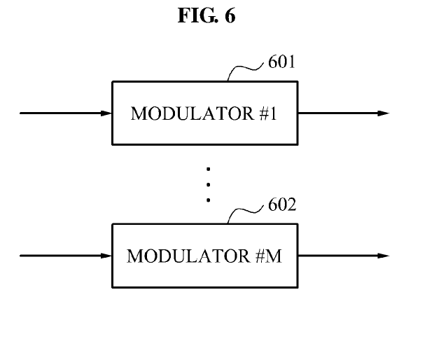

FIG. 6 illustrates an example of modulator.

Referring to FIG. 6, the modulator 206 may modulate combined signals combined by the combiner 205, based on at least one predetermined modulation scheme among various modulation schemes. Modulators including a modulator #1 601 through a modulator #2 602 may respectively apply different modulation schemes to M signals outputted from the combiner 205, M being the same as a number of the plurality of transmission antennas 207, to respectively transmit the modulated signals to the plurality of transmission antennas 207. At least two signals among outputted signals from the combiners 205 may be modulated based on the same modulation scheme. Therefore, each of signals may be modulated based on an optimal scheme among various modulation schemes.

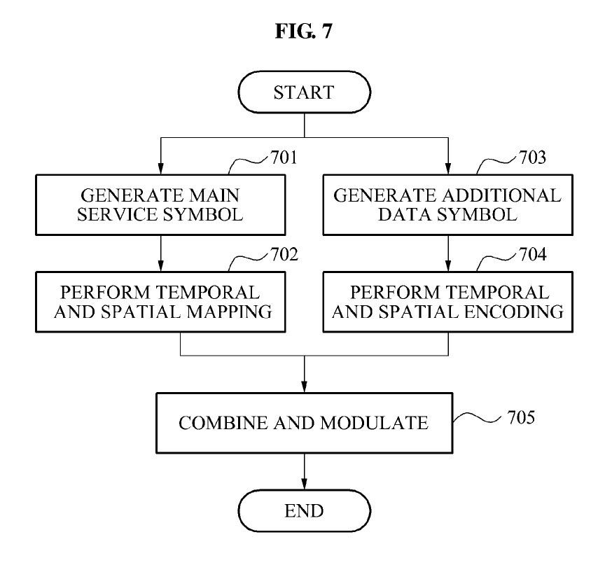

FIG. 7 illustrates a method of providing a terrestrial DTV broadcast and transmitting additional data via the plurality of transmission antennas 207 according to an embodiment of the present invention.

Referring to FIG. 7, main service symbols for a terrestrial DTV broadcast main service are generated in operation 701, and the main service symbols are mapped to a plurality of transmission antennas in operation 702.

In this case, the mapping in operation 702 may map, using the at least one switch 301, each of the main service symbols to a unique transmission antenna, among the plurality of transmission antennas 207, at different times, and a sequence of switching the transmission antennas may be fixed as a predetermined sequence or may randomly vary. Therefore, an optimal switching time and an optimal antenna to be switched among the plurality of transmission antennas 207 may be selected, and a temporal and spatial mapping may be performed.

The mapping in operation 702 may map, using the at least one switch 401, the main service symbols to the plurality of transmission antennas 207 at the same time. The main service symbols may be mapped to all the transmission antennas at the same time. In operation 703, additional data symbols for an additional data service are generated, and the additional data symbols are temporal and spatial encoded to generate transmission symbols to be transmitted to the plurality of transmission antennas 207 in operation 704.

The additional data service may be a service provided in addition to a DTV broadcast service. A transmission of the additional data may provide additional broadcast service in addition to the existing DTV broadcast, and may provide data service such as an education service, a stock service, a public announcement service, and the like, in addition to the existing DTV service. In addition, additional information, such as program information, associated with the main service may be transmitted. A range of the additional data service may not be limited thereto, and a variety of information may be included.

The encoding in operation 704 may receive, as inputs, K additional data symbols and may generate T×M temporal and spatial encoded symbols to be transmitted to M transmission antennas during a T time duration, K being an integer number.

Subsequently, symbols to be transmitted via the plurality of transmission antennas 207 are generated based on the main service symbols and the additional data symbols in operation 705.

The generating in operation 705 may combine temporal and spatial encoded main service symbols and the temporal and spatial encoded additional data symbols, and may modulate, using the modulators including the modulator #1 601 through the modulator #M 602, the combined symbols to generate the symbols to be transmitted via the plurality of transmission antennas 207.

In this case, the combining of the temporal and spatial mapped main service symbols and the temporal and spatial encoded additional data symbols may be performed by adding outputs of operation 702 and outputs of operation 703.

In this case, the modulating of the combined symbols to generate symbols to be transmitted via the plurality of transmission antennas 207 may modulate the outputs of the combining operation based on at least one predetermined modulation scheme among various modulation schemes. The modulators including the modulator #1 601 through the modulator #M 602 may respectively apply different modulation schemes to signals and respectively transmit the signals to the plurality of transmission antennas 207. At least two signals among the outputs of the combining operation may be modulated based on the same scheme. Therefore, an optimal scheme among various modulation schemes may be selected and each of the signals may be modulated.

To transmit additional data inserted in a base band of a terrestrial DTV broadcast signal using the plurality of transmission antennas 207, the additional data signal may be temporal and spatial encoded or may be temporal and spatial multiplexed, and may be combined with a base band DTV broadcast signal before modulation, and the additional data may be simultaneously transmitted and thus, a transmission efficiency of the additional data may increase without affecting a performance of a terrestrial DTV broadcast receiver.

The method according to the above-described embodiments of the present invention may be recorded in non-transitory computer readable media including program instructions to implement various operations embodied by a computer. The media may also include, alone or in combination with the program instructions, data files, data structures, and the like. The described hardware devices may be configured to act as one or more software modules in order to perform the operations of the above-described embodiments of the present invention, or vice versa.

A method of providing a terrestrial DTV broadcast and transmitting additional data using a plurality of antennas has been described. Examples described with reference to FIGS. 2 through 6 may be applicable to the method of providing the terrestrial DTV broadcast and transmitting the additional data using the plurality of antennas and thus detailed description thereof will be omitted.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An apparatus of transmitting for a broadcasting service, the apparatus comprising:
a main service symbol generating unit to generate main service symbols for a main service;
a temporal and spatial mapping unit to perform temporal and spatial mapping of the main service symbols to a plurality of transmission antennas;
an additional data symbol generating unit to generate additional data symbols for an additional data service;
to a temporal and spatial encoder to perform temporal and spatial encoding of the additional data symbols; and
a processor to generate symbols to be transmitted via the plurality of transmission antennas based on the main service symbols and the additional data symbols.

2. The apparatus of claim 1, wherein the temporal and spatial mapping unit is at least one switch that switches each of the main service symbols to be mapped to a unique transmission antenna, among the plurality of transmission antennas, at different time slots.

3. The apparatus of claim 1, wherein the temporal and spatial mapping unit is at least one switch that switches the main service symbols to be mapped to the plurality of transmission antennas at the same time slot.

4. The apparatus of claim 1, wherein the processor comprises:
a combiner to combine outputs of the temporal and spatial mapping unit and outputs of the temporal and spatial encoder; and
a modulator to modulate outputs of the combiner to generate symbols to be transmitted via the plurality of transmission antennas.

5. The apparatus of claim 4, wherein the combiner adds the outputs of the temporal and spatial mapping unit and the outputs of the temporal and spatial encoder.

6. The apparatus of claim 4, wherein the modulator modulates, based on at least one predetermined modulation scheme, signals combined by the combiner.

7. The apparatus of claim 1, wherein the temporal and spatial encoder generates to the temporal and spatial encoded symbols so that T×M symbols are transmitted via M transmission antennas during a T time duration.

8. A method of transmitting for a broadcasting service, the method comprising:
generating main service symbols for a main service;
performing temporal and spatial mapping of the main service symbols to a plurality of transmission antennas;
generating additional data symbols for an additional data service;
performing temporal and spatial encoding of the additional data symbols; and
generating symbols to be transmitted via the plurality of transmission antennas based on the main service symbols and the additional data symbols.

9. The method of claim 8, wherein the mapping switches each of the main service symbols to be mapped to a unique transmission antenna, among the plurality of transmission antennas at different time slots, using at least one switch.

10. The method of claim 8, wherein the mapping switches the main service symbols to be mapped to the plurality of transmission antennas at the same time slot, using at least one switch.

11. The method of claim 8, wherein the generating comprises:
combining, by a combiner, the temporal and spatial mapped main service symbols and the temporal and spatial encoded additional data symbols; and
modulating, by a modulator, outputs of the combiner to generate symbols to be transmitted via the plurality of transmission antennas.

12. The method of claim 11, wherein the combining adds the temporal and spatial mapped main service symbols and the temporal and spatial encoded additional data symbols.

13. The method of claim 11, wherein the modulating modulates, based on at least one predetermined modulation scheme, signals combined by the combiner.

14. The method of claim 8, wherein the temporal and spatial encoding generates the temporal and spatial encoded symbols so that T×M symbols are transmitted via M transmission antennas during a T time duration.
